(19) United States
(12) Patent Application Publication
(10) Pub. No.: US 2001/0050910 A1
(43) Pub. Date: Dec. 13, 2001

(54) Method for transmitting wireless packet data in mobile communication system

(76) Inventor: Se Jong Oh, Ichon (KR)

Correspondence Address: BAKER & BOTTS, 30 ROCKEFELLER PLAZA, NEW YORK, NY, 10112

(21) Appl. No.: 09/846,950

(22) Filed: May 1, 2001

(30) Foreign Application Priority Data
Jun. 13, 2000 (KR) 2000-32357

(51) Int. Cl. H04J 3/00

(52) U.S. Cl. 370/336; 370/345; 370/442

(57) ABSTRACT

Disclosed is a method for transmitting wireless packet data in a mobile communication system, which can provide a high-quality wireless packet data service at a lower cost by enabling a common data channel, which is used to transmit bursting data to terminals, to function as a dedicated data channel. The method for transmitting wireless packet data in the mobile communication system comprises the steps of: initializing a call processor within a base station, receiving a setup message from the terminals and simultaneously receiving a time table assignment request message from the control station; generating a packet data call instance in response to the received time table assignment request message; updating a time table and generating a radio burst protocol (RBP) instance; and transmitting the slot information message through the paging channel to the terminals and transmitting a time table assignment completion message to the control station.

### BACKGROUND OF THE INVENTION

1. Field of the Invention

The present invention generally relates to a method for transmitting wireless packet data in a mobile communication system, and more particularly, to a method for transmitting wireless packet data in a mobile communication system, which can provide a high-quality wireless packet data service at a lower cost by enabling a common data channel, which is used to transmit bursting data to terminals, to function as a dedicated data channel.

2. Description of the Related Art

In general, a downlink shared channel (DSCH) is used to transmit wireless packet data in a IMT-2000 system from a base station system to a mobile station system, while a common packet channel (CPCH) is used to transmit wireless packet data in a IMT-2000 system from a mobile station system to a base station system.

FIG. 1 is a schematic diagram illustrating a configuration of a general mobile communication system for a wireless packet data service. Referring to FIG. 1, the mobile communication system includes a mobile station 10, a base station 30, a control station 20, and a mobile communication switching system 40. Here, the mobile station 10 is comprised of a call process controller (CC), a radio resource controller (RRC), and channel elements (CE), whereas the control station 20 is comprised of a call process controller (CC) and a radio resource controller (RRC). The base station 30, meantime, is comprised of channel elements (CE) for transmitting and receiving wireless data to and from the mobile station 10.

The fact that the mobile station 10 is connected to the control station as drawn in FIG. 1 is just a way to show that the control station 20 is functionally much more significant in assigning channels than the base station 30. However, it is desirable to think that an universal terrestrial radio access network (UTRAN) containing the base station 30 and control station 20 actually performs the channel assignment.

In a mobile communication system constructed as above, the DSCH is used to transmit wireless packet data from the base station 30 to the mobile station 10, and the CPCH is used to transmit the wireless packet data from the mobile station 10 to the base station 30. Further, the DSCH and CPCH performs the assignment in layers of a call resource controller (RRC) contained in the UTRAN and constitute the individual channels. Here, the channel constitution means such information as a scrambling code, a spreading factor, an acceptable data rate, etc.

The DSCH generally used to transmit the data packet from the base station 30 to the mobile station 10 is shared among numeral mobile stations to transmit data packets. Here, quality of service, a data rate, and a traffic volume requested by the mobile stations are different, respectively.

The data rate means how much amount of data is transmitted per time, generally specifying an average transmission rate and a maximum transmission rate for data to be transmitted through a call before the call is set up. In addition, the traffic volume having a similar meaning to the data rate signifies a total amount of data transmitted for a predetermined period of time. That is, the term of traffic volume is used to explain in connection with an amount endurable by a buffer, which is present in a data collection section. The traffic volume repeatedly increases and decreases depending on the amount of data. To be specific, in case of internet traffic, a huge amount of data is generated in a certain section but a small amount of data is generated in other sections. The traffic volume in the input buffer repeatedly increases and decreases because of such a fluctuation of the traffic volume.

In the meantime, in the event that there is an increase in the traffic volume of data packets transmitted from the DSCH, which is shared among the numerous mobile stations, to a certain mobile station 10, a conventional method for settling the problem of increased traffic volume of data packets is to reduce the spreading factor.

It is currently essential to efficiently utilize the radio source for a high speed packet data service provided by the IMT-2000 system. For this, attempts have been directed to accept a bursting traffic through a common data channel shared among the plurality of terminals.

As a result, in the conventional wireless communication techniques, the packet data communication is carried out over the transmission channel having a predetermined band. The method is relatively simple but has a disadvantage of increasing the possibility of incurring delay or data loss since it can not treat efficiently the traffic of the packets having bursting features.

To alleviate the disadvantage, there has been tried to find a common data channel commonly usable among all the mobile stations within the IMT-2000 system. However, the approach causes a problem that all the terminals should always be reading the common channel to transmit the data through the common channel, thereby resulting in a waste of processing capacity of the terminals and high power consumption.

### SUMMARY OF THE INVENTION

It is, therefore, an object of the present invention to provide a method for transmitting wireless packet data in a mobile communication system, which can provide a high-quality wireless packet data service at a lower cost by enabling a common data channel, which is used to transmit bursting data to terminals, to function as a dedicated data channel.

According to the present invention, information concerning time division is transmitted to all mobile stations through a common control channel (equivalent to a paging channel in a IMT-2000 system) by applying a time division multiple access (TDMA), which is used when a frequency is simultaneously used by a plurality of users, to a code division multiple access (CDMA) channel.

Further, according to the present invention employing the aforementioned time division, each mobile station is assigned each time slot during which it can use the common data channel for data transmission. Whenever information of the time division varies, a base station transmits the varied information to all the mobile stations.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic diagram illustrating a configuration of a general mobile communication system for a wireless packet data service;

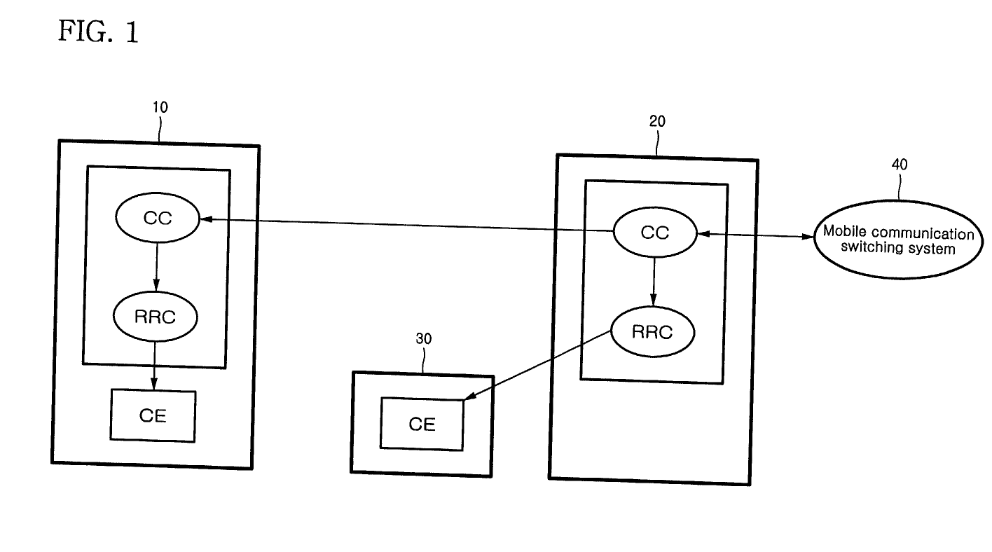

FIG. 2 is a diagram illustrating a setup flow of a virtual dedicated data channel, which is applied to a wireless packet data service in a mobile communication system of the present invention; and

FIG. 3 is a flow chart illustrating a call processing by a call processor within a base station, in the course of the wireless packet data service in the mobile communication system of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

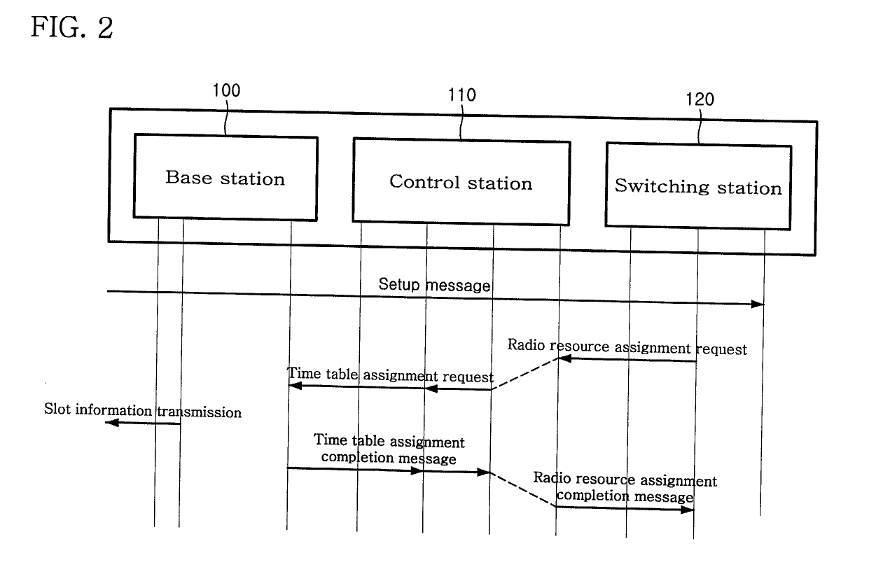

FIG. 2 is a diagram illustrating a setup flow of a virtual dedicated data channel, which is applied to a wireless packet data service in a mobile communication system of the present invention.

Referring to FIG. 2, once a terminal (mobile station) transmits a setup massage through a base station 100 to a switching station 120, the switching station 120 requests a radio resource assignment of a control station 110.

If the control station 110 is requested the radio resource assignment by the switching station 120, it requests a time table assignment of the base station 100. If the base station 100 is requested the time table assignment by the control station 110, it assigns and then transmits a slot information through a paging channel to the mobile station. At the same time, the base station 100 transmits a message indicating that the time table assignment has been completed to the control station 110, and the control station 110 transmits a message indicating that the radio resource assignment has been completed to the switching station 120.

Meanwhile, a call processor, which provides the virtual dedicated data channel applied to the wireless packet data service in the mobile communication system of the present invention, roughly includes: a time table, which is referred to during an access to the virtual dedicated data channel; a call instance, namely information concerning terminals performing the packet data service; and a radio bursting protocol (RBP), which performs a link protocol function when transmitting the packet data through the virtual dedicated data channel. Here, the conventional RBP transmitting a bursting traffic can perform only a transmission function with no capability of detecting or correcting errors. However, the RBP in the virtual dedicated data channel becomes capable of correcting such simple errors as order check, or the like.

It will be described herein below an operation of the common data channel of the present invention, to which the time division access is applied by using the call processor within the base station constructed above.

For example, if three terminals indicated at A, B and C, request the packet data service, the call processor 111 within the base station automatically assigns time slots during which the terminals can use the common data channel, respectively, and generates the call instance where the corresponding time slot information is recorded.

The call processor 111 within the base station notifies all the terminals of the updated time slot information through the paging channel, and after this, each terminal reads the common data channel only during the time slot assigned thereto.

The time slots assigned to the terminals should be different from one another depending on the size of bursting traffic transmitted through the common data channel. But, at the beginning, the time period is properly determined based on statistics in a simple and uniform manner.

In the event that a terminal commences a data service or ends its data service, the time table of the call processor 111 within the base station has become changed. Whenever the time table varies, the call processor 111 notifies all the terminals within a cell of this variation through the paging channel.

In this manner, the terminal A reads the common data channel only during a time slot [A], the terminal B reads the common data channel only during a time slot [B], and the terminal C reads the common data channel only during a time slot [C]. After reading, they interpret and process the packets transmitted to themselves.

Therefore, the problem of continuously interpreting the common data channel by all the terminals has been eliminated, and the time consumed for one terminal to interpret the received data has also become shortened. In addition, as a region for designating terminals is not needed in a packet header for transmitting data to the terminals, the size of the data transmitted to the common data channel has become also reduced. Accordingly, such an effect as if employing the dedicated data channel can be made by using the common data channel without setting up an additional dedicated channel.

Since the common data channel has a limited number of time slots, if the number of terminals using the packet data service within a cell increases, another common data channel may be set up additionally. The variation in relation to the setup of another common data channel is also notified to all the terminals through the paging channel.

The dedicated channel is optimumly assigned with no burden of the bursting traffic when determining whether or not the packet data service is acceptable. This is because that once the packet data service is accepted, the call processor within the base station automatically assigns each time slot available for the common data channel to each terminal.

If received data are beyond the band of the dedicated channel, they are transmitted to the RBP of the base station to be sent through the common data channel, and the RBP transmits the data during the time slot assigned thereto.

Since only one RBP exists in the conventional common data channel, it cannot treat any error. However, according to the present invention one RBP is generated per terminal, and hence is capable of treating a simple error as if it is a radio link protocol.

As stated above, the present invention can develop all the advantages of the dedicated channel while using the common channel at a lower cost.

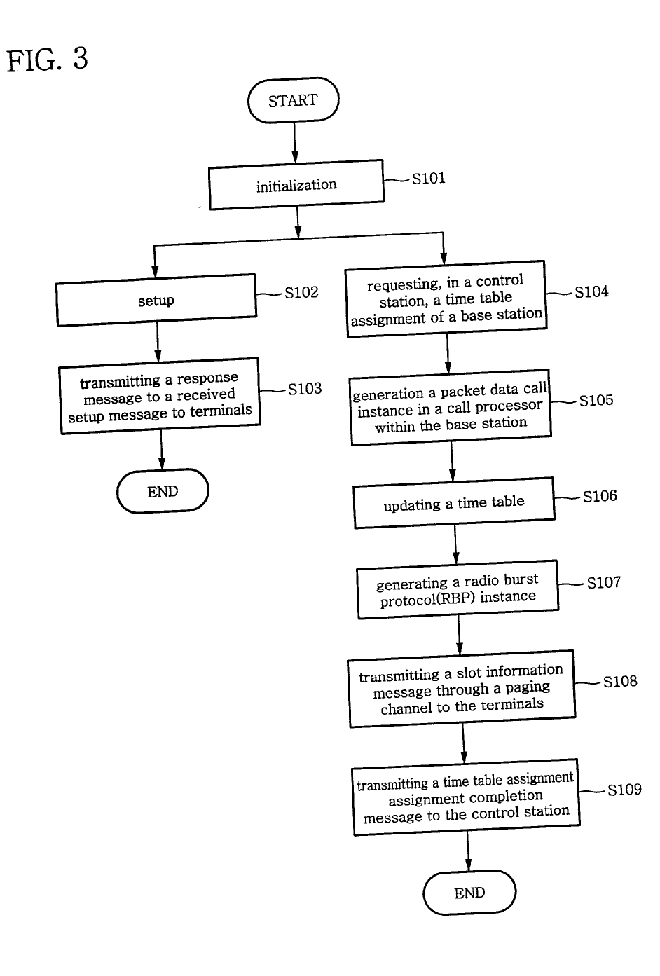

A call processing by the call processor within the base station will be described herein below with reference to FIG. 3.

FIG. 3 is a flow chart illustrating the call processing by the call processor within the base station, in the course of the wireless packet data service provided by the mobile communication system of the present invention.

First, the call processor 101 within the base station 100 is initialized at step 101, and receives the setup message from the terminals at step 102.

The call processor 101 within the base station 100 transmits the response message to the received setup message at step 103.

Thereafter, the control station 110 transmits the time table assignment request message to the call processor 101 within the base station 100 at step 104.

The call processor 101 within the base station 100 generates the packet data call instance at step 105 after receiving the time table assignment request message from the control station 110.

Next, the call processor 101 within the base station 100 updates the time table at step 106, and generates the RBP instance at step 107.

The base station 100 transmits the slot information message through the paging channel to the terminals at step 108, and transmits the time table assignment completion message to the control station 110 at step 109.

As described above, the wireless packet data service in the mobile communication system according to the present invention has advantages of efficiently treating the bursting traffic during the wireless packet data service, abtaining the dedicated channel effect with the common channel, promoting reliability on the communication through the common data channel since the RBP of the call processor within the base station has been improved to perform the error correction function, and considerably raising the extent of utilizing the virtual dedicated data channel by appending an algorithm referring to service kinds and QoS when time slots are assigned to the respective terminals performing the packet data service.

The wireless packet data service in the mobile communication system according to the present invention has further advantages of compactly assigning the dedicated data channel since the burden of the bursting packet traffic is eliminated, and enabling the user to receive the data service at a much lower cost than the existing data service which is provided by means of only the dedicated channel, since the user can use the inexpensive common channel with respect to the bursting data.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting wireless packet data in a mobile communication system, which comprises a base station having a call processor therewithin, a control station and terminals, the method comprising the steps of:
initializing the call processor within the base station, and then receiving a setup message from the terminals and simultaneously receiving a time table assignment request message from the control station;
generating a packet data call instance in response to the received time table assignment request message;
updating a time table and generating a radio bursting protocol (RBP) instance; and
transmitting a slot information message through a paging channel to the terminals and transmitting a time table assignment completion message to the control station.

2. The method of claim 1, wherein when transmitting the information message from the base station to the terminals, a time slot available to a common data channel is assigned to each channel by transmitting the common data channel in a time division manner

3. The method of claim 1, further comprising the step of transmitting, in the call processor within the base station, a response message to the setup message received from the terminals.
